(19) United States
(12) Patent Application Publication
(10) Pub. No.: US 2003/0103188 A1
(43) Pub. Date: Jun. 5, 2003

(54) Contact lens

(76) Inventor: Harry I. Zeltzer, Ipswich, MA (US)

Correspondence Address: JOSEPH ZALLEN, STE 1012, 3500 GALT OCEAN DRIVE, FORT LAUDERDALE, FL, 33308, US

(21) Appl. No.: 10/252,241

(22) Filed: Sep. 23, 2002

Related U.S. Application Data
(60) Provisional application No. 60/334,961, filed on Dec. 4, 2001.

(51) Int. Cl. G02C 7/04

(52) U.S. Cl. 351/162

(57) ABSTRACT

A pupil reduction corneal contact lens having a light-admitting central area surrounded by a light-blocking area. The central area can be clear or have a slight tint for reducing glare that would not reduce visual acuity to 20/25 or less. The lenses can be soft, gas-permeable or hard.

### CROSS-REFERENCE

The Applicant hereby invokes the benefits of 35 U.S.C. 119(e)(1) with respect to the invention disclosed by the Applicant in pending provisional application S. No. 60/334,961 filed Dec. 4, 2001.

### BACKGROUND OF INVENTION

This invention relates to a novel corneal contact lens which corrects refractive errors but also reduces aberrations, thus improving visual acuity to the highest possible level for contact lens correction.

There are many aberrations of the cornea. The larger the pupil the greater the aberrations.

1. Spherical aberrations are caused by a gradual flattening of its peripheral curvature. Therefore, light has variable foci which smear the image and reduce contrast.

2. Coma aberration occurs where light that enters the pupil off the visual axis (at an angle) will appear as a fuzzy circle. The farther it is off the axis as through a larger pupil, the larger is the circle. The circle takes on a comet-like image thus reducing visual acuity.

3. Barrel aberration is a distortion of an image that is magnified centrally more than its peripherally. This results in the center bowing out. Everything is in focus but points in the image will not be in their proper place.

4. Chromatic aberration is a focal variation of color, blue light having a stronger focus than red.

Correction of corneal aberrations can be achieved with refractive surgery as, for example, Lasik. However, surgery is not always successful and can result in post-operative problems.

### SUMMARY OF THE INVENTION

This invention comprises a pupil reduction corneal contact lens that reduces corneal aberrations and provides better than standard visual acuity. The lens provides maximum visual acuity by reducing the effects of corneal aberrations, corneal irregularities and abnormal pupils.

The lens has a light-admitting central area surrounded by a light-blocking area. The central area can be clear or have a slight tint for reducing glare that would not reduce visual acuity to 20/25. The lens can be soft, gas-permeable or hard. The lens may be plano or with lens power and can be used for one or both eyes. At night when more light is required, the patient may if he/she wishes use only one eye having a pupil reduction lens.

In a preferred form the central area is surrounded by a light-blocking ring and has a central area of variable size for the visual axis of the eye. The blocking ring may be colored black to simulate a larger pupil or instead have a desired color. The color can be painted, silk screened, stamped or imprinted on the lens. The blocking ring may also be a composite of both black and color. These options provide cosmetic choice.

The amount of pupil reduction needed for a particular individual can be determined subjectively by using a trial set of lenses that have pupils ranging from 1 mm to 4 mm. A lens made in accordance with this invention typically has a lens thickness in the order of 0.15 mm. The size of the lens depends on the size of the eye to be fitted in the range of ˜11 mm to 15 mm. The average diameter of the cornea of an eye is 12 mm. However, many individuals have diameters which are larger or smaller and eyelid opening larger or smaller. Similarly, the average radius of a cornea is between 42 and 44 diopters but many corneas are steeper and flatter. Proper positioning of the lens of the present invention on a cornea is dependent on these factors as well as weight.

A pupil reduction contact lens made in accordance with this invention will approximate refractive surgery results without the dangers of surgery.

### BRIEF DESCRIPTION OF DRAWINGS

FIG. 1 is a schematic front view of the embodiment described in Example 1.

FIG. 2 is a schematic front view of the embodiment described in Example 2.

### SPECIFIC EXAMPLES OF INVENTION

Following are two examples of the construction of soft lenses made in accordance with this invention.

### Example 1

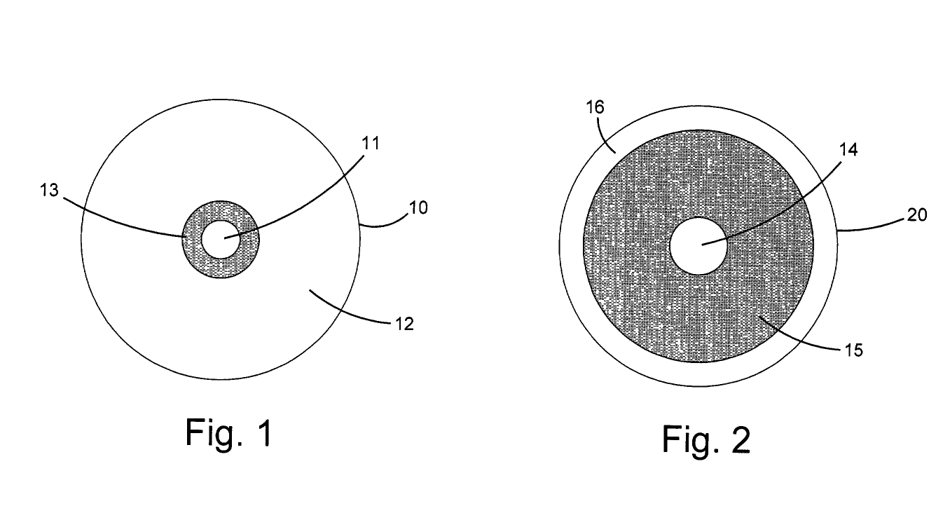

Referring now to FIG. 1 showing a schematic front view of an eye treated in accordance with this invention, a clear soft corneal contact lens 10 having a diameter of 14.5 mm is coated on its external para center surface with a light blocking ring 13 of black dye. The 2 mm center 11 remains clear and has the correct lens power to allow for a very sharp retinal image in daylight. The width of the black ring 13 surrounding the clear center is 1 mm to provide an apparent pupil size of 4 mm. when inserted onto the cornea. The remaining 5.25 mm. portion 12 of the lens is clear.

### Example 2

Referring now to FIG. 2 showing a schematic front view of an eye treated in accordance with this invention, a clear soft corneal contact lens 20 having a diameter of 14.5 mm. is coated on its external para center surface with a 4.5 mm. wide light blocking ring 15 of a selected color and has a 3 mm. wide clear central pupil 14. The remaining outer 1.25 mm. wide ring 16 is clear.

### EXAMPLES OF HOW THE INVENTION HELPS EYE PROBLEMS

### Example 3

A patient with bilateral corneal irregularity and best corrected visual acuity of 20/40 in each eye with soft contact lenses, would if fitted with a pupil reduction lens made in accordance with the specifications below and using the same soft lens material and prescription, have an increase in visual acuity in each eye to 20/25.

Specifications:

O.U. −1.50 Diopters, Radii 8.30 mm., diameter 13.8 mm., thickness 0.19 mm., clear pupil diameter 2 mm., black pupil ring (1 mm.), remainder of lens clear.

### Example 4

A patient with myopia and best corrected visual acuity of 20/20 in each eye wearing gas-permeable lenses would if fitted with a pupil reduction lens made in accordance with the specifications below and using the same lens material and prescription, have an increase in visual acuity in each eye to 20/10.

Specifications:

OD 2.00 diopters, Radius 8.35, diameter 9.2 mm., thickness 0.15 mm.

O.S. 2.25 diopters, Radius 8.35, diameter 9.2 mm., thickness 0.15 mm.

2 mm. lightly tinted pupil center to reduce glare

black pupil ring 1 mm., remaining lens light blue.

### Example 5

A patient with hyperopic astigmatism with best corrected visual acuity of 20/20 in each eye wearing gas permeable lenses, would if fitted with a pupil reduction lens for the left non-dominant eye made in accordance with the specifications below and using the same lens material and prescription, have an increase in visual acuity in the non-dominant eye to 20/10.

Specifications:

O.S. −1.75 diopters, radius 8.9 mm. diameter 9.0 mm., thickness 0.05 mm. clear pupil diameter 3 mm., black pupil ring 1 mm., remainder of lens clear (to create the same pupil size as the right eye.)

### Example 6

A patient with myopia wearing soft contact lenses, would, if fitted with a pupil reduction lens made in accordance with the specifications below and using the same soft lens material and prescription, have an increase in visual acuity in each eye from 20/200 to 20/10.

Specifications:

hema

O.U. −1.50 diopters, radii 8.30 mm., diameter 13.8 mm., thickness 0.19 mm.,

clear pupil diameter 2 mm.

Remainder of lens blue

1. A pupil reduction corneal contact lens having a light-admitting central area surrounded by a light-blocking area.

2. The lens of claim 1 wherein said light-blocking area is selected from the characterizing group consisting of black, a selected color and a composite of black and a selected color.

3. The lens of claim 1 wherein said light blocking area is a ring.

4. The lens of claim 3 wherein said ring is selected from the characterizing group consisting of black, a selected color and a composite of black and a selected color.

5. The lens of claim 1 wherein said central area has a soft tint for reducing glare.

6. The lens of claim 1 wherein said central area is clear.

7. A method for increasing visual acuity in a selected eye which comprises the step of applying to said eye a pupil reduction corneal contact lens having a light-admitting central area surrounded by a light-blocking area.

8. The method of claim 7 wherein said light blocking area is a ring.

9. The method of claim 7 wherein said light-blocking area is selected from the characterizing group consisting of black, a selected color and a composite of black and a selected color.

10. The method of claim 7 wherein said central area has a soft tint for reducing glare.

11. The method of claim 7 wherein said central area is clear.

12. The method of claim 7 wherein said selected eye is myopic.

13. The method of claim 7 wherein said selected eye is astigmatic.
